(19) United States
(12) Patent Application Publication
(10) Pub. No.: US 2014/0054422 A1
(43) Pub. Date: Feb. 27, 2014

(54) FOLDING KITE WITH A CENTRAL ASSEMBLY SHAFT

(71) Applicant: EOLO SPORT INDUSTRIAS, S.A., Gijon (ES)

(72) Inventor: Alejandro Prieto Estebanez, Gijon (ES)

(73) Assignee: EOLO SPORT INDUSTRIAS, S.A., Gijon (ES)

(21) Appl. No.: 14/025,687

(22) Filed: Sep. 12, 2013

Related U.S. Application Data
(63) Continuation of application No. 13/188,179, filed on Jul. 21, 2011, now abandoned.

(30) Foreign Application Priority Data
Jul. 26, 2010 (ES) 201000789

(51) Int. Cl. B64C 31/06

(52) U.S. Cl. CPC B64C 31/06
USPC 244/153 R

(57) ABSTRACT

A folding kite with a central assembly shaft, or rod, having a generally isosceles triangular-shaped cloth. The front, lateral sides of the cloth form respective tube-like formations for the insertion of rods coming together in a front vertex in an articulated manner. The front-lateral structure includes a central rod dividing the kite into two symmetrical parts. On the central rod, there are assembled in a sliding manner one or more intermediate connectors and a rear connector, which form insertion coupling for respective ends of front and rear rods that at the opposite end thereof are linked with corresponding side connectors arranged for that purpose on the rods assembled on the tube-like formations arranged in the front-lateral edges of the cloth of the kite. The sliding of the connectors on the central rod allows for quick folding or extension of the general structure of the kite.

INCORPORATION BY REFERENCE TO ANY PRIORITY APPLICATIONS

This application is a continuation of U.S. patent application Ser. No. 13/188,179, which claims priority to Spanish Patent Application No. 201000789, filed 26 Jul. 2010. The contents of all of the above-referenced applications are incorporated herein by reference in their entireties.

### OBJECT OF THE INVENTION

The present invention relates to a folding kite with a central assembly shaft, specifically being of the type referred to as a “delta” kite, formed from a partially planar laminar body of cloth or the like, with a contour that tends to be isosceles triangular shaped, being stiffened by means of a framework.

The object of the invention is to obtain a kite of the aforementioned type, the framework of which has structural features allowing the folding and extending thereof in a very fast and simple manner specifically with a single movement of the hand.

Another object of the invention is to provide the kite with optimal structural strength.

### BACKGROUND OF THE INVENTION

### Description of the Related Art

As is known, any kite and particularly “delta” kites are assembled and disassembled to reduce the space they take up when not in use, the framework being formed by means of a plurality of rods which are fixed at their ends within connection points between them and to the laminar body, such that their final structure is the result of the connection between at least eight different points with connections that are made manually. The type of connection or parts connecting the rods to the cloth of the kite may range from bands gripping the rod to simple elbows receiving the rods therein, but in any case the assembly and disassembly operations are slow and complicated.

In the attempt to overcome that problem, the same applicant is the proprietor of Utility Model U 200802075 which discloses a folding kite based on a laminar body of cloth that can be folded or extended with the aid of a framework in which there are two front-lateral rods housed in tube-like formations of the cloth attached to one another in an articulated manner at the inner end thereof and converging with two other rods which are divergently directed towards the rear edge of the cloth at points provided with rubber connectors receiving in turn another pair of rods extending between those points and the middle area of the aforementioned transverse and intermediate rods traversing two other rubber connectors, these two transverse and intermediate rods being fixed at their outer end in the middle area of the front edge of each half of the cloth, whereas at their inner end they converge in a central connector intersecting with a rod linking the front vertex with the mid-point of the rear edge, the aforementioned rubber connectors forming articulated, non-removable attachments, and the central connector having a fixing clamp for being fixed to the front-rear and middle rod at any point along same in order to stabilize the framework both in the extension position and in the folded situation of the cloth.

The applicant is also the proprietor of Utility Model U 200802460, which discloses a folding kite the structure of which is formed from two front-lateral rods attached to one another in an articulated manner at one of their ends and housed in respective tube-like formations of the front edge of the cloth, collaborating with two pairs of flexible rods, two main ones and two secondary ones or “whiskers”, those two pairs of rods being linked to one another through a central housing to which they are attached in an articulated manner, which central housing is provided with quick connection practicable tongue and groove coupling means for coupling to a complementary housing arranged on the rear middle area of the body of the kite.

In turn, the main rods are fixed at their free end to the front-lateral rods in the rear middle area thereof whereas the secondary rods or “whiskers” are fixed at their free end at respective points coinciding with the areas of maximum concavity of the profile defined at the rear edge of the kite.

Although the kites described in these two aforementioned Utility Models satisfactorily perform the function for which they were designed, they do have an opening and closing, i.e., extending and folding, which can be improved in practice as can the strength of the structure of the kite.

### SUMMARY OF THE INVENTION

The proposed structure has precisely been conceived to comply with the feature mentioned in the last paragraph of the preceding section, i.e., to get the kite to be easy to fold and extend, to be functionally simple and to further offer high strength in terms of the final framework final of the kite.

More specifically, the structure of the kite is formed from a central rod acting as a central shaft dividing the kite into two symmetrical and lateral halves, the folding and extended operations being performed in a sliding manner through that central rod quickly and easily.

In addition to that central rod, the structure has two front-lateral rods housed in respective tube-like formations arranged for that purpose on the front-lateral edges of the cloth or material itself from which the kite is made such that those two rods housed in the tube-like formations are articulated to one another at a preceding point where the cloth of the kite forms an obtuse angle.

The front-lateral rods housed in the tube-like formations have plastic connectors at intermediate points which in one case are coupling means for the end of front transverse rods and in another case for rear transverse rods, such that those rods in both cases are fixed at their other end, i.e., at the inner end, in respective central connectors assembled in a sliding manner on the central rod, and on which sliding connectors there are assembled in an articulated manner respective arms with a blind hole in which precisely the ends of both front and rear transverse rods are inserted, thus forming a simple, easy to fold and furthermore strong structure.

The arms in which the ends of the transverse rods are inserted have at their end opposite the blind hole an open transverse circular formation which is positioned on shafts arranged transversely in grooves provided for that purpose in the sliding connectors sliding on the central rod themselves, thus forming the articulation of the arms and therefore of the rods inserted therein.

The number of sliding connectors sliding on the central rod may vary and therefore the number of rods may vary depending on the strength to be provided to the structure of the kite, which therefore allows reinforcing said structure or framework and thereby increasing resistance to wind.

With the exception of the central connectors, i.e., the connectors sliding on the central rod, and the corresponding arms articulated thereon, the remaining attachments are stable with the collaboration of an adhesive.

All the connectors assembled in a sliding manner on the central rod will be attached by a wire or cord such that when pulling on any of its end connectors, all the connectors assembled on the central rod will move with a sliding movement through said central rod, allowing the assembly or folding of the kite in a fast and easy movement.

### BRIEF DESCRIPTION OF THE DRAWINGS

To complement the description made below and for the purpose of aiding to better understand the features of the invention according to a preferred practical embodiment thereof, a set of drawings is attached as an integral part of said description in which the following has been depicted with an illustrative and non-limiting character:

FIG. 1 shows a depiction corresponding to a front view of the kite and all the components that form it.

FIG. 2 shows a front view of the kite in its initial assembly or folding phase.

FIG. 3 shows a front view of the kite in its intermediate assembly or folding phase.

FIG. 4 shows a front view of the kite in its complete folded phase.

FIG. 5 shows an enlarged exploded perspective detail view of the rear central connector in the kite.

FIG. 6 shows the same assembly depicted in the preceding figure in its assembled or folded phase.

FIG. 7 shows an enlarged exploded perspective detail view of the front central connector in said kite.

FIG. 8 shows a perspective view of one of the side connectors assembled on the front-lateral rods.

FIG. 9 shows an enlarged, also exploded, perspective detail view of the front central connector in the kite.

FIG. 10 shows an enlarged, also exploded, perspective detail view of the central connector of the preceding figure seen from a different angle.

### DETAILED DESCRIPTION OF THE PREFERRED EMBODIMENT(S)

As can be seen in the mentioned figures, the kite of the invention, like any conventional kite, is formed from a laminar body (1) that can be of cloth or another suitable material, the front edge (2) of which configures a tube-like formation and at the same time an obtuse angle, whereas its rear edge (3) is lobe-shaped.

Respective rods (4) converging in an articulation vertex (5) in correspondence with the front point of the kite are housed in the tube-like formations defined in the front edge (2) of the cloth.

Rubber connectors (13) are assembled on said rods (4) in which connectors transverse rods (12, 16) are fixed by insertion, the former being considered as rear rods and the latter being considered as front rods, such that those rods (12, 16) are fixed at their inner end, i.e., at the opposite end, in respective connectors (18, 20) assembled in a sliding manner on the central rod (14) from which the structure of the kite per se is formed.

The inner end of the transverse rods (12, 16) is fixed or connected on the rear connector (18) and front connector (20) with the interposition of arms (23) provided at one end with an axial blind hole where the corresponding transverse rod (12, 16) is coupled and inserted, whereas the opposite end of said arms (23) has a narrowed transverse passage (23′) that is formed in the articulation means on respective transverse shafts (25) arranged in grooves (28) formed for that purpose in the connectors (18, 20) on both sides of the central core through which those connectors (18, 20) are assembled in a sliding manner on the central rod (14), whereby the arms (23) are located in the grooves (28) and assembled in an articulated manner as has just been explained.

The sliding rear connector (18) sliding on the central rod (14) will have free movement through the latter, further forming part of a tongue and groove system that can be quickly and easily coupled to a female housing (19) through a flexible spear rod, that female housing (19) being fixed by adhesive through the central rod in correspondence with its rear part.

The connector or connectors (20) assembled in a sliding manner on the rod (14) also move freely on the latter without being associated in this case with the female housing (19) of the rear connector (18).

The connectors (18, 20) are linked to one another through a wire or cord (17) which passes through and is fixed on a hole (26) of the rear connector (18) and other holes (27) provided in the front connector or connectors (20).

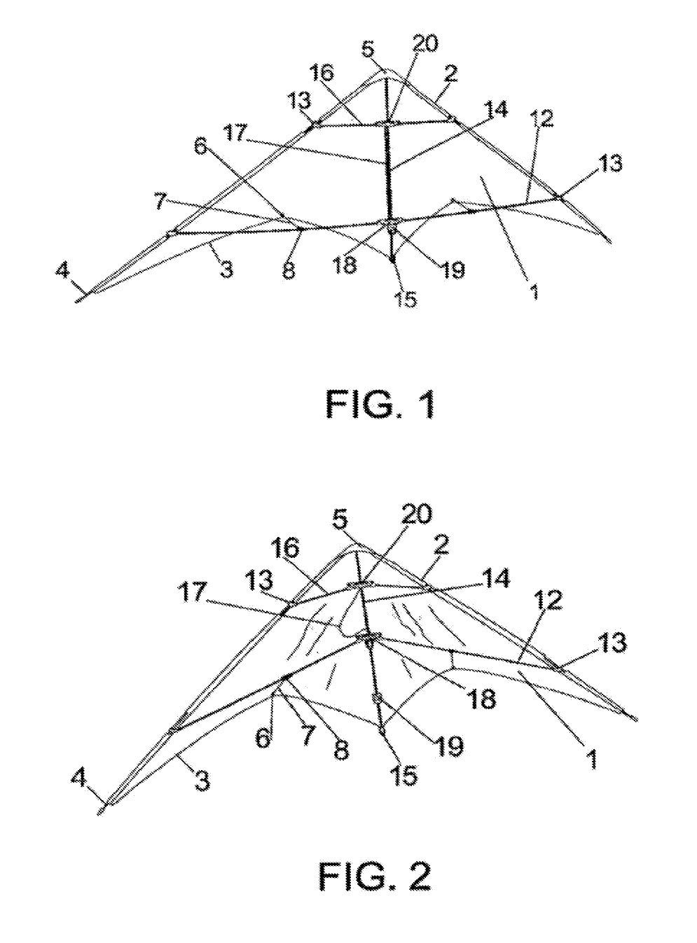

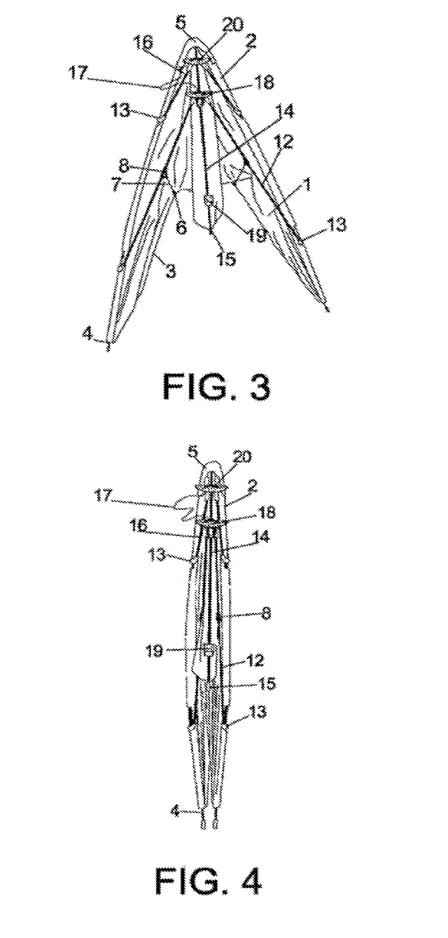

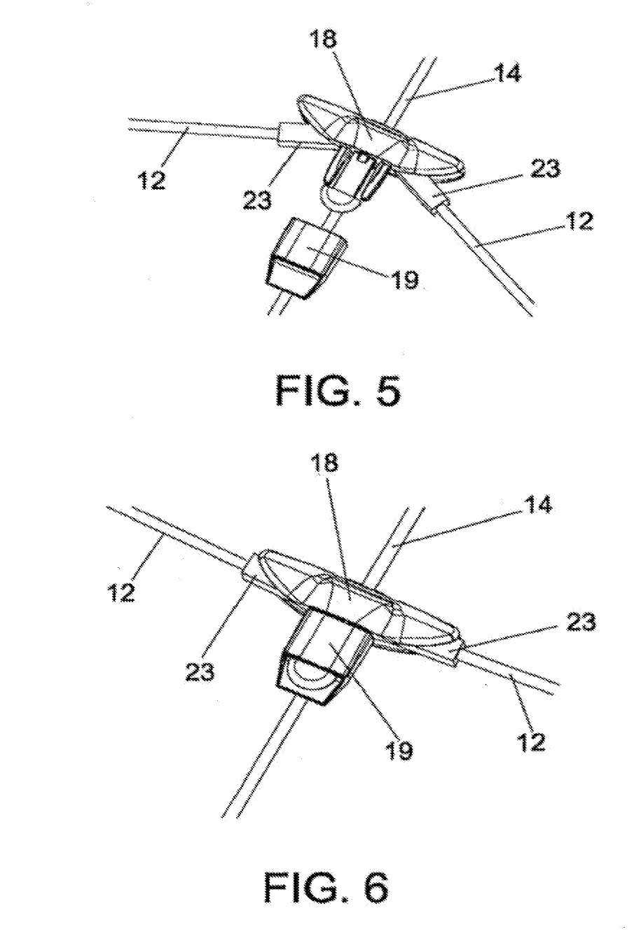

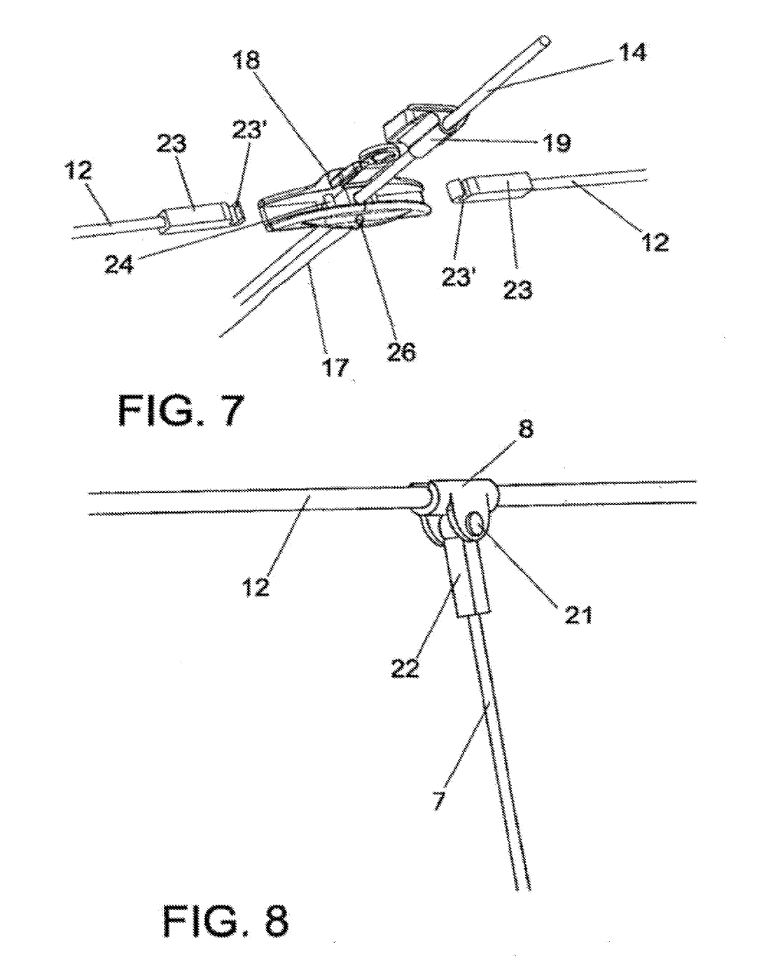

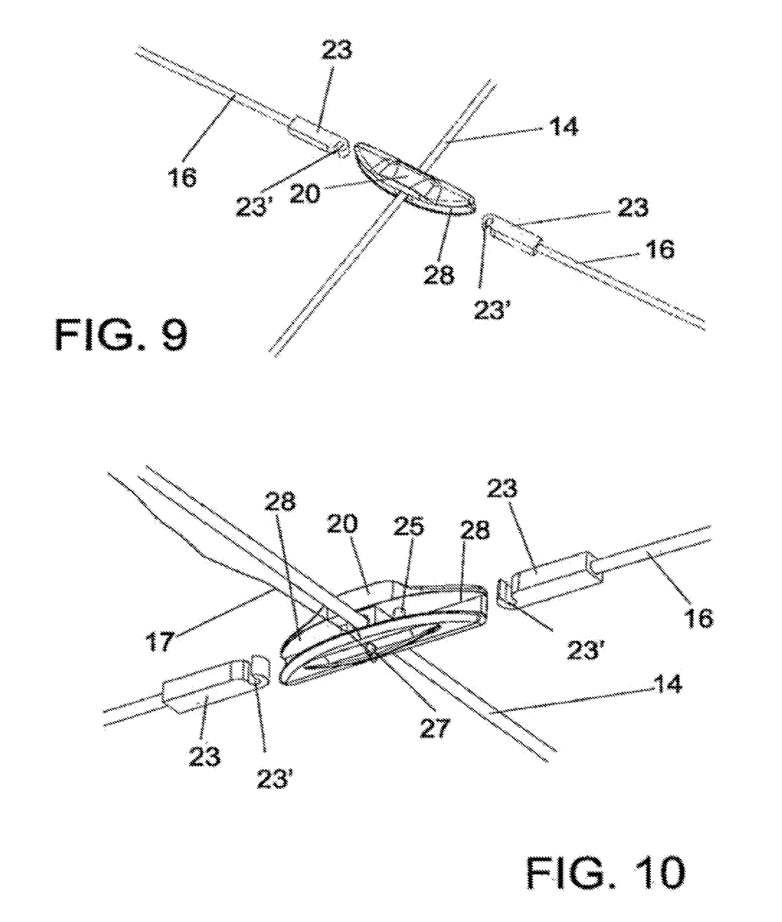

In addition, it has been provided that the rear transverse rods (12) in turn incorporate respective connectors (8) at intermediate points of those rods (12) and fixed by means of an adhesive, and to which connectors (8) respective rods (7) are fixed in an articulated manner whereby the sail is tensed, the latter being provided at its rear edge with another connector (6) duly fixed to the cloth itself, as can be seen in FIGS. 1 and 2. Each rod (7) is further connected to the respective connector (8) through a part (22) with an axial blind hole where the end of the respective rod (7) is fixed by insertion, that part (22) being assembled in an articulated manner through a shaft (21) for the rotation of the former, and which shaft (21) is located in the connector (8) itself, as can be seen in FIG. 8.

1. A folding delta kite comprising:
an isosceles triangular shaped cloth, the front-lateral sides of which form respective tube-like formations in which there are inserted respective rods coming together in a front vertex in an articulated manner,
a central rod dividing the kite into two symmetrical and identical parts,
connectors assembled on the central rod in a sliding manner,
wherein the connectors comprise a front connector and a rear connector, which form insertion coupling means for respective ends of front transverse rods and rear transverse rods, and opposite ends of the transverse rods are linked with corresponding side connectors arranged on the rods assembled on the tube-like formations arranged in the front-lateral edges of the cloth of the kite, such that the sliding of the connectors on the central rod allows for quickly folding or extending the kite.

2. The folding kite with a central rod according to claim 1, wherein the transverse rods are connected to the sliding connectors sliding on the central rod through arms with an axial blind hole in which the inner end of the transverse rods is housed, wherein the opposite end of the arms has a narrowed open transverse hole, which can be assembled in an articulated manner on corresponding shafts arranged in grooves provided in the sliding connectors on the central rod.

3. The folding kite with a central rod according to claim 1, wherein the sliding rear connector sliding on the central rod is coupled in a female housing through a flexible spear rod, said female housing assembled on the central rod at a point close to the rear end thereof, the female housing being assembled in a fixed manner.

4. The folding kite with a central rod according to claim 1, further comprising a connector located at an intermediate point of each of the rear transverse rods and fixed to the rear transverse rods for forming an articulated connection means for a support rod for tensing the cloth, and wherein an opposite end of the support rod is connected to another connector fixed on the cloth of the kite.

5. The folding kite with a central rod according to claim 1, wherein the sliding connectors sliding on the central rod are linked to one another through a wire or cord, which is fixed to a through-hole of the sliding rear connector sliding on the central rod and to a hole arranged in the sliding front connector sliding on the central rod.
